(19) United States
(12) Patent Application Publication
(10) Pub. No.: US 2025/0348071 A1
(43) Pub. Date: Nov. 13, 2025

(54) System and Method for Volumetric Space Monitoring Using Time-Series Analysis of Non-Visual Spectrum Image Data on Mobile Platforms

(71) Applicant: Plume Digital LLC, Mill Run, PA (US)

(72) Inventor: Corey Forster, Mill Run, PA (US)

(21) Appl. No.: 19/202,558

(22) Filed: May 8, 2025

Related U.S. Application Data
(60) Provisional application No. 63/645,424, filed on May 10, 2024.

(51) Int. Cl. G05D 1/243; G05D 111/10; H04N 7/18

(52) U.S. Cl. CPC G05D 1/243; H04N 7/18; G05D 2111/14

(57) ABSTRACT

A system and method are provided for monitoring volumetric spaces by integrating non-visual spectrum sensor modules with mobility platforms. The invention addresses limitations of traditional visual inspection by enabling automated, time-series analysis of spatially distributed physical properties. Sensors including but not limited to radiometric infrared imaging, optical gas imaging, and acoustic imaging are spatially and temporally registered to generate comparable scalar field data, which are analyzed to detect changes, trends, or anomalies. The system supports both two-dimensional and three-dimensional workflows, allowing for flexible mission planning and data analysis. Key innovations include the use of virtual sensors, robust spatial registration, and the application of reduced order models for inferring internal conditions from external measurements. The invention is applicable to industrial, environmental, and security monitoring, providing continuous, non-invasive assessment of complex assets and environments.

### CROSS-REFERENCE TO RELATED APPLICATIONS

This patent application is related to and claims the benefit of priority of U.S. Provisional Application No. 63/645,424, filed on May 10, 2024, titled “System and method to monitor a volumetric space via instance analysis and time series analytics of data from autonomous unmanned vehicles (AUVs) using non-visual spectrum camera-based sensors,” which is incorporated herein by reference in its entirety.

### STATEMENT REGARDING FEDERALLY SPONSORED RESEARCH AND DEVELOPMENT

This invention was not made with any federal funding, and no government rights are associated with it.

### FIELD OF THE INVENTION

The present invention relates to systems and methods for monitoring volumetric spaces using advanced sensor technologies and data processing techniques. Specifically, it involves the integration of multi-modal sensor modules, including non-visual spectrum cameras, with mobility platforms to perform time-series analysis and detect changes, trends, or anomalies within a given space.

### BACKGROUND OF THE INVENTION

Traditional methods for monitoring volumetric spaces, particularly in commercial and industrial settings, have predominantly relied on manual inspections and visual spectrum cameras. However, imaging devices that capture data in the non-visual spectrum offer significant advantages by enabling the detection of conditions imperceptible to the human eye. For instance, radiometric infrared imaging can measure apparent surface temperatures, optical gas imaging can identify hydrocarbon gas emissions, and acoustic imaging can detect noises used for pneumatic leak detection or mechanical vibrations. Despite these advancements, the interpretation of data from these imaging techniques is often subject to human perceptual error or misinterpretation of changing conditions.

Existing monitoring systems for volumetric spaces are limited by reliance on manual inspection, visual spectrum imaging, and static data analysis, which restrict detection of subsurface or non-visible conditions and hinder continuous, automated assessment. Prior art systems often lack integration of multi-modal sensors, advanced spatial registration, and time-series analytics, resulting in reduced sensitivity to evolving conditions and increased risk of undetected failures. Prior art in this field can be appreciated from US20170334559A1, KR 20230080729A, US 20220291701A1, US20220055749A1, and US20140172392A1.

In contrast to prior art, the present invention uniquely integrates non-visual spectrum sensor modules with mobile platforms, enabling automated, repeatable data collection and advanced time-series analysis. The system's ability to generate and analyze virtual sensors, perform robust spatial and temporal registration, and apply reduced order models for condition inference distinguishes it from existing solutions focused solely on static imaging or manual inspection.

### SUMMARY OF THE INVENTION

The present invention provides a comprehensive system and method for monitoring volumetric spaces using advanced sensor technologies and data processing techniques. Unlike prior systems, this invention integrates a diverse range of mobility platforms, including autonomous and operator-guided devices, with multi-modal sensor modules that feature non-visual spectrum imaging. This integration allows for detailed spatial and temporal analysis, enabling the detection of changes, trends, and anomalies within a given space. The invention is implemented using physical sensor hardware and mobile platforms, resulting in the transformation of real-world physical measurements into actionable, spatially and temporally registered data structures.

One of the system's innovative aspects is its ability to perform time series analysis, generating comparable scalar field arrays that represent orthographic projections of spatially distributed physical properties or distillation of these arrays into a 3-dimensional digital structure.

This capability allows for comparative analysis across multiple time points, significantly enhancing the system's monitoring capabilities. The invention is particularly suited for applications in environmental monitoring, industrial inspection, and security surveillance, offering a versatile and effective solution for detecting and analyzing changes within volumetric spaces.

An exemplary embodiment relates to a system for monitoring volumetric spaces using time-series analysis. The system includes a multi-modal sensor module including at least one imaging modality operable in a non-visual wavelength spectrum, the multi-modal sensor module configured to generate data of a volumetric space. The system includes a mobility platform module configured to carry, integrate, and/or position the multi-modal sensor module, the mobility platform module including a navigable mission plan configured to guide the mobility platform through the volumetric space. The system includes a data processing module configured to cause the multi-modal sensor module to perform one or more inspection instances by generating data of the volumetric space in accordance with the navigable mission plan for each inspection instance. The data processing module is configured to generate one or more scalar field arrays based on a time series analysis of the data, the one or more scalar field arrays being representative of one or more orthographic projections of spatially distributed physical properties of the volumetric space. The data processing module is configured to align, compare, and analyze the one or more scalar field arrays to detect a change, a trend, and/or an anomaly within the volumetric space.

In some embodiments, the imaging modality includes: one or more radiometric infrared cameras; one or more near infrared cameras; one or more ultraviolet cameras; one or more optical gas imaging cameras; one or more acoustic imaging cameras; and/or one or more multi-spectral imaging cameras.

In some embodiments, the multi-modal sensor module is configured to perform spatial sensing and generate spatial sensing data. The spatial sensing is performed by one or more visual spectrum imaging cameras configured to provide an image-based three-dimensional (3D) reconstruction via photogrammetry, neural radiance fields (NeRF), 3D gaussian splatting (3DGS), stereo vision, monocular depth estimation, and/or structured light projection; and/or one or more active ranging sensors configured to perform direct spatial measurements supported by localization via a LiDAR camera and/or a time-of-flight camera. The data processing module is configured to derive spatial structure or identify spatial features of the volumetric space from the spatial sensing data.

In some embodiments, the data processing module is configured to associate spatial positioning and/or temporal metadata via data obtained from a localization sensor modality of the multi-modal sensor module. The localization sensor modality includes: one or more global positioning system (GPS) modules; one or more real time kinetics (RTK) modules; one or more post processing kinetics (PPK) modules; one or more inertial measurement units (IMU) modules; one or more visual odometry (VO) modules; and/or one or more simultaneous location and movement (SLAM) modules.

In some embodiments, the mobility platform is configured to carry, integrate, and/or position the multimodal sensor module in or on an autonomous or operator guided device. The autonomous or operator guided device includes: one or more unmanned aerial vehicles (UAVs); one or more autonomous ground vehicles (AGVs); one or more autonomous underwater vehicles (AUVs); one or more handheld devices; one or more wearable devices; and/or one or more mobile phones comprising a sensor augmentation attachment for non-visual spectrum modality.

In some embodiments, the navigable mission plan includes one or more defined data collection actions along a defined path or coverage pattern through the volumetric space. The one or more data collection actions include one or more discrete data collection actions at one or more sets of waypoints and/or one or more continuous data acquisition actions along one or more splines.

In some embodiments, the defined path or coverage pattern is based on a two-dimensional analysis, a pixel-based analysis workflow, a three-dimensional analysis, and/or a voxel-based analysis workflow. The one or more sensor modality parameters for the defined path or coverage pattern are optimized for comparative analysis.

In some embodiments, the system is configured to execute the navigable mission plan performed autonomously, semi-autonomously, and/or by guided direction of a system operator. Each execution is an instance of inspection. Each instance of inspection repeats the navigable mission plan with consistent sensor modality parameters, consistent mobility platform orientation, and consistent spatial coverage of the volumetric space.

In some embodiments, the system is configured to perform a series of inspection instances by repeated execution of the navigable mission plan across plural distinct timepoints. The data processing module is configured to generate comparative, trend-based, and/or time-series analyses of the volumetric space.

In some embodiments, the data processing module is configured to generate one or more data analysis pipelines for analyzing scalar field arrays from a non-visual spectrum imaging device collected from a series of inspection instances. The one or more data analysis pipelines includes: (i) a two-dimensional analysis pipeline based on comparison of aligned orthographic projections or arrays of scalar field data; and/or (ii) a three-dimensional analysis pipeline based on comparison of scalar field data mapped to a meshed, point cloud, splat, and/or voxel representations.

In some embodiments, the data processing module is configured to convert one or more raw arrays of scalar field data and associated metadata into one or more spatially normalized and temporally sequential data structures for comparative analysis.

In some embodiments, the data processing module is configured to perform the two-dimensional analysis pipeline by: a) using localization metadata to identify corresponding scalar field arrays from the at least one imaging modality operable in a non-visual wavelength spectrum across the series of inspection instances; and b) applying spatial sensing data to align the corresponding scalar field arrays at the pixel level using one or more registration techniques, the one or more registration techniques including a photogrammetry target technique, a computer vision target technique, a structure-from-motion (SfM) technique, a scale-invariant feature transform (SIFT) technique, a COLMAP technique, a feature-based matching technique, a mutual information technique, and/or a photogrammetric adjustment technique.

In some embodiments, the data processing module is configured to perform the three-dimensional analysis by: a) processing spatial sensing data into a volumetric model; b) using localization metadata to assign scalar field values from the at least one imaging modality operable in a non-visual wavelength spectrum to specific spatial locations, thereby compiling all non-visual spectrum data from a specific instance of inspection into a 3D representation that is directly comparable to other non-visual spectrum data across the series of inspection instances through a common coordinate system; and c) using a photogrammetry target technique and/or a computer vision target technique for registration.

In some embodiments, the system includes use of a segmentation routine configured to define virtual sensors as individual pixels, pixel groupings, voxels, or voxel groupings, said virtual sensors being spatially registered for comparative analysis across time.

In some embodiments, the data processing module is configured to summarize or transform virtual sensor data using a statistical summarization technique, a rule-based inference technique, a physics-based model technique, a finite element model technique, a computational fluid dynamics technique, and/or a reduced order model technique.

In some embodiments, the data processing module includes a time-series analysis engine configured to analyze virtual sensor data across a series of inspection instances to identify a trend, forecast a condition, and/or detect an anomaly within the volumetric space.

An exemplary embodiment relates to a method for monitoring volumetric spaces using time-series analysis. The method involves generating data of a volumetric space via an imaging modality operable in a non-visual wavelength spectrum. The method involves guiding a mobility platform via a navigable mission plan. The method involves performing one or more inspection instances by generating data of the volumetric space in accordance with the navigable mission plan for each inspection instance. The method involves generating one or more scalar field arrays based on a time series analysis of the data, the one or more scalar field arrays being representative of one or more orthographic projections of spatially distributed physical properties of the volumetric space. The method involves detecting a change, a trend, and/or an anomaly within the volumetric space by aligning, comparing, and/or analyzing the one or more scalar field arrays.

In some embodiments, guiding the mobility platform via the navigable mission plan involves use of one or more defined data collection actions along a defined path or coverage pattern through the volumetric space.

In some embodiments, the defined path or coverage pattern is based on a two-dimensional analysis, a pixel-based analysis workflow, a three-dimensional analysis, and/or a voxel-based analysis workflow.

In some embodiments, the method involves repeating the navigable mission plan with consistent sensor modality parameters, consistent mobility platform orientation, and consistent spatial coverage of the volumetric space for each instance of inspection.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The accompanying drawings are referenced throughout the following description to illustrate representative embodiments of the invention. It should be understood that the inventive concepts disclosed herein may be implemented in a variety of forms, configurations, and combinations of components, as well as through different sequences of steps. The drawings are provided solely to facilitate understanding of certain embodiments and should not be interpreted as limiting the scope of the invention. Additionally, the relative proportions and dimensions depicted in the drawings are not necessarily to scale.

FIG. 1 illustrates a schematic diagram of the Volumetric Monitoring System (100). The system comprises a Mobility Platform Module (120) and a Multi-Modal Sensor Module (110), which are configured to operate within a monitored volumetric space. The Navigation and Mission Execution Module (130) is depicted as facilitating navigation of the mobility platform throughout the three-dimensional space. The system further includes a data processing environment, represented by two computing devices: one configured for two-dimensional (2D) image processing (140) and the other configured for three-dimensional (3D) model processing (150). This figure provides an overview of the primary system components and their functional relationships within the volumetric monitoring solution.

FIG. 2 illustrates the Multi-Modal Sensor Module (200). The module includes a non-visual spectrum imaging sensor modality (210), represented by a lens configured for capturing data in non-visual wavelengths. A separate lens is depicted for the spatial sensor modality (220), which is configured to perform spatial sensing functions such as mapping three-dimensional structures or identifying spatial features. The localization sensor modality (230) is shown with directional and orientation indicators, demonstrating the module's capability to track both position and orientation within the monitored volumetric space.

FIG. 3 illustrates the Mobility Platform Module (300). The module is represented as a platform capable of movement and delivery, indicated by directional and orientation arrows. The figure depicts several exemplary embodiments: an aerial drone or unmanned aerial vehicle (UAV) (310), a quadruped robot representing ground or terrestrial vehicles (320), a submersible vehicle as an aquatic embodiment (330), a handheld device featuring a sensor mounted on a gimbal (340), a wearable device such as a sensor mounted on a hardhat (350), and a mobile phone with a sensor attachment (360). These embodiments collectively demonstrate the versatility of the mobility platform for deploying sensor modules across a range of operational environments.

FIG. 4 illustrates the Navigation and Mission Execution Module (400) and its associated components. The figure depicts the execution of a mission around a volumetric space. A waypoint (410) is shown as a defined position, orientation, and sensor action within the space. A mission (420) is represented as a series of waypoints connected either linearly or via a spline. Repeated execution of a mission (430) is illustrated as a series of missions performed at distinct time points. Operator control modes (440-442) are depicted, including an operator, an operator holding a handheld device as a mobility platform, an operator guiding a drone using a remote control, and an operator programming a quadruped robot using a laptop. This figure demonstrates the flexibility and repeatability of mission planning and execution within the system.

FIG. 5 illustrates the digital data processing and analytics workflow for two-dimensional (2D) data. The figure depicts a sequence of representative steps: a laptop displaying an image with a processing icon (500), a laptop with a series of images being transferred into a database icon (510), a laptop with a series of images in sequential order (520), a laptop showing an image with reference locations or targets (520), an image undergoing segmentation with a highlighted region (530), a segmented image with a magic wand icon indicating data augmentation (540), a segmented image with a probability icon representing statistical summarization (541), a segmented image with a flag icon denoting rule-based notification (542), a segmented image with a formula icon f (x) indicating modeling of underlying scalar field data (543), and finally, a laptop displaying a series of labeled images (1st, 2nd, 3rd, Nth) with a trend icon (550). This figure provides an overview of the digital processes involved in 2D data analysis within the system.

FIG. 6 illustrates the digital data processing and analytics workflow for three-dimensional (3D) data. The figure depicts a sequence of representative steps: a 3D model icon with a processing icon (600), a series of images being converted to a 3D model (610), a 3D model with targets or spatial references such as ground control points (620), a 3D model with a single side highlighted to indicate segmentation (630), a segmented 3D model with a magic wand icon indicating data augmentation (640), a segmented 3D model with a probability icon representing statistical summarization (641), a segmented 3D model with a flag icon denoting rule-based notification (642), a segmented 3D model with a formula icon f (x) indicating modeling of underlying scalar field data (643), and finally, a laptop displaying a series of labeled 3D models (1st, 2nd, 3rd, Nth) with a trend icon (650). This figure provides an overview of the digital processes involved in 3D data analysis within the system.

FIG. 7 illustrates an industrial use case involving a reduced order model for thermodynamic modeling of a refractory system. The figure presents a simplified output, where 700 shows all relevant inputs, outputs, and associated meta data. Element 710 depicts internal (process) and external (ambient) temperature inputs. Element 720 presents theoretical apparent shell temperatures, which may be used for comparative analysis when real-world values are measured by the volumetric monitoring system. Element 730 illustrates a multi-layer refractory design, including a simulated erosion of the innermost layer. This figure demonstrates the application of the system to process vessel monitoring and integrity assessment.

FIGS. 8A-8M show a mathematical sub-division technique using an “octree” system.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems and methods using and making the same disclosed herein have been discussed and illustrated, it is to be distinctly understood that the invention is not limited thereto but may be otherwise variously embodied and practiced within the scope of the following claims.

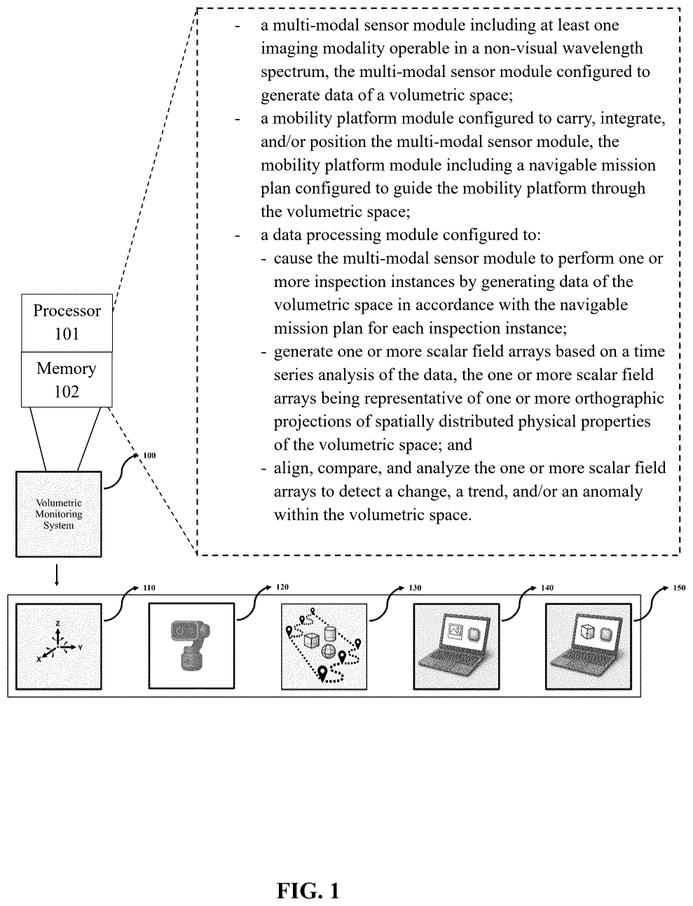

The emergence of autonomous unmanned vehicles (AUVs) and advanced sensor technologies has introduced new opportunities for automated and precise monitoring of volumetric spaces. However, existing systems frequently lack the capability to integrate multiple sensor modalities and to perform comprehensive, high-fidelity data analysis. The present invention addresses these limitations by integrating multi-modal sensor modules with a mobility platform, thereby enabling detailed spatial and temporal analysis of data generated by non-visual spectrum imaging devices. The system is configured to generate scalar field arrays and to conduct comparative analysis across multiple time points, which substantially enhances the detection and analysis of changes, trends, and anomalies within volumetric spaces. As a result, the invention is particularly well-suited for applications in environmental monitoring, industrial/commercial inspection, and security surveillance, providing a robust and versatile solution for monitoring and analyzing complex environments. The present invention provides a comprehensive system and method for monitoring volumetric spaces using time-series analysis. As illustrated in FIG. 1, the volumetric monitoring system (100) comprises a mobility platform module (110) configured to carry and position a multi-modal sensor module (120) through a volumetric space. The system further includes a navigation and mission execution module (130) that guides the mobility platform module (110) to ensure structured data collection to enable time series analysis of the volumetric space.

The system (100) or any of its components can include one or more processors 101 and one or more memories 102. The processor(s) 101 can be configured to execute instructions to facilitate signal processing, data manipulation, data storage, execution of algorithms, etc. For instance, any of the processors 101 can be in operative association with memory which includes instructions (e.g., logic, algorithms, models, etc.) stored thereon that when executed by the processor 101 will cause the processor 101 to carry out one or more of the functions disclosed herein. It is contemplated for the processors 101 to receive electrical, optical, and/or electro-optical signals, process those signals, perform computations with the processed signals, and transmits information and/or commands to other components. Thus, the processors 101 can be equipped with lead lines, waveguides, electrical/optical connectors/couplers, switches/circuitry, processing blocks, analog-to-digital converters (ADC), digital-to-analog converters (DAC), filters, processing blocks, transceivers, antennas, and so forth to facilitate receiving/transmitting, processing, and storing signals and data.

Any of the processors 101 can include or be operatively associated with a memory 102. The memory 102 can store instructions thereon which can be executed by the processor 101 to perform any of the functions disclosed herein. The instructions can be in the form of computer logic, algorithms, models, etc. and stored as a computer program, a data structure, etc. While exemplary embodiments may describe and/or illustrate the system (100) with one processor 101 and one memory 102, it is understood that the system (100) or any of the component of the system (100) can include any number of processors 101 and memories 102.

The processor 101 can be part of or in communication with a machine (logic, one or more components, circuits (e.g., modules), or mechanisms). The processor 101 can be hardware (e.g., processor, integrated circuit, central processing unit, microprocessor, core processor, computer device, etc.), firmware, software, or any combination thereof configured to perform operations by execution of instructions embodied in algorithms, data processing program logic, artificial intelligence programming, automated reasoning programming, and so forth. Use of processors 101 herein can include any one or combination of a Graphics Processing Unit (GPU), a Field Programmable Gate Array (FPGA), a Central Processing Unit (CPU), etc. The processor 101 can include one or more operating modules. An operating module can be a software or firmware operating module configured to implement any of the method steps disclosed herein. The operating module can be embodied as software and stored in memory, the memory being operatively associated with the processor 101. An operating module can be embodied as a web application, a desktop application, a console application, etc.

The processor 101 can include or be associated with a computer or machine-readable medium. The computer or machine-readable medium can include memory. The computer or machine-readable medium can be configured to store one or more instructions thereon. The instructions can be in the form of algorithms, program logic, a model, or any combination therefor that cause the processor 101 to perform any of the functions described herein.

Any of the memory 102 discussed herein can be computer readable memory configured to store data. The memory 102 can include a volatile or non-volatile, transitory or non-transitory memory, and be embodied as an in-memory, an active memory, a cloud memory, or any combination thereof. Embodiments of the memory 102 can include an operating module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, waveguides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, or any combination thereof.

The processor 101 can be in communication with other processors 101 of other devices (e.g., a computer device, a desktop computer, a laptop computer, a computer system, etc.). Any of those other devices can include any of the exemplary processors 101 disclosed herein. Any of the processors 101 can have transceivers or other communication devices/circuitry to facilitate transmission and reception of wireless signals. Any of the processors 101 can include an Application Programming Interface (API) as a software intermediary that allows two applications to talk to each other. Use of an API can allow software of the processor 101 of the system (100) to communicate with software of the processor 101 of the other device(s), if the processor of the system (100) is not the same processor of the device.

Any data transmission between a processor 101 and a memory 102, between a processor 101 and a database, between a processor 101 and processors 101 of other devices, between a processor 101 of one operating module and a processor of another operating module, etc. can be via a pull operation (e.g., the processor 101 can pull the data) or a push operation (e.g., the data can be pushed to the processor). The processor 101 can receive and process the data in steaming format, store it in memory before being processed, etc.

The processor 101 can be configured to be a component of, used in combination with, or in communication with another device/system—e.g., this can include the processor 101 being part of the device/system, the device/system being part of the processor 101, the processor 101 in communication with the device/system, etc. “Being part of” can include being on a same substrate or integrated circuit.

The processor 101 can be a component of, used in combination with, or in communication with a predictive modeling system, a decision support system, an automated control system, etc. The processor 101 can use the techniques disclosed herein to assist with or augment the performance of these devices/systems.

The system further comprises data processing modules, including a 2D data processing module (140) and a 3D data processing module (150) as shown in FIG. 1, each configured to condition and structure data according to its dimensionality. The 2D data processing module (140) is adapted for data represented as arrays of pixels, while the 3D data processing module (150) is adapted for data associated with a three-dimensional coordinate system, such as point clouds, meshes, neural radiance fields, Gaussian splats, or voxels. These modules are configured to prepare the data for time series analysis by performing alignment or registration to enable comparability across inspection instances, and by segmenting the data into areas or volumes of interest defining ‘virtual sensors’ as pixels and/or pixel groupings as well as voxels and/or voxel groupings thereby facilitating independent tracking of sensor data over time within each defined area or volume of interest.

Non-limiting, exemplary implementations of the alignment/registration and segmentation techniques are as follows.

It is contemplated for alignment and registration to both involve data analysis techniques that are route dependent.

Using a 2D case as an example, an inspection is performed (e.g., generating data of the volumetric space in accordance with the navigable mission plan) to obtain images of the volumetric space. The inspection can include plural inspection instances—the inspection can comprise several inspection instances performed for the same volumetric space, for a section of the volumetric space, for a specific perspective of the volumetric space, etc. This can be done to generate a series of images from a specific perspective, for example. While any image in that series can be used as a baseline image (e.g., facilitating key point calculation(s)), it is contemplated for the first image in that series to be designated and used as a baseline. Use of a baseline image is also useful for segmentation (discussed later).

The baseline image provides key point calculation(s) by the system (100) defining or identifying mathematically significant pixels (e.g., analogous to the image's fingerprint). This same process is done for the following images in the series associated with the same inspection waypoint (e.g., images taken at the same inspection waypoint). After key points are calculated for each image in the series, the key points are compared to the key points of the baseline to generate tie points. A tie point is a mathematical representation of key points spanning several images, as determined by identifying key points in images that match with key points in the baseline image.

The system (100) creates an array of images in the series. Pixel location information for the baseline image and the other images in the series are used to align/register the images by generating a transform and via use of cropping to ensure pixel locations within the array are identical. This ensures pixel comparisons are akin to physical comparisons.

It is contemplated for a 3D case alignment/registration to be dependent on localization data use. It is understood, however, that even with localization data (like GPS), it is beneficial to use targets or to perform some sort of feature-based registration. This can include feature-based registration techniques discussed above, a hybrid of such techniques, use of point cloud data, etc. For instance, scalar data can be collected and formatted into a point cloud for a given inspection. Subsequent inspections can use “cloud-to-cloud” alignment (e.g., a mathematical approach to move one dataset to the same space as another). Other approaches can include, rigid registration, affine registration, deformable registration, etc. It is also possible to use machine learning techniques to perform a rough alignment, then a finer alignment, etc.

Even in a drone-based inspection case (e.g., mobility platform modality is a drone w/a multi-modal sensor modality as a payload), where all locations are geotagged and have Real-Time Kinematic (RTK) enhanced GPS data, it still can be beneficial to use targets or to perform some sort of feature-based registration. First, GPS and RTK data depends on accuracies and procedures used during RTK setup. Second, assigning targets (which are usually placed during the inspection) as specific locations can be beneficial due to the fact that these targets persist for subsequent inspections.

The targets can be computer vision targets (e.g., AprilTags, ArUco boards, etc.). With a computer vision target technique, a pattern that is recognizable by computer vision is used as a target, and the system (100) assigns a point in space and a number to the target. This number can be used as a spatial ID, and can be formatted as a digital number, an encrypted QR code, etc. These patterns can be permanent fixtures or semi-permanent fixtures within the volumetric space being inspected. For instance, an operator can add permanent mount(s) (e.g., fixtures that will be used as recognizable patterns) before inspection. This technique can also be beneficial in that the fixtures provide spatially tagged and numbered points that are easy to use for algorithmic alignment. In addition, these targets and IDs can be used in GPS-denied locations or scenarios. Another benefit is that this process can tag data containing alignment points and identifiers algorithmically without human intervention.

For segmentation, it is important to ensure that the same asset is being compared (e.g., the images/models are registered and aligned, as described above). It is contemplated for the segmentation process to be an algorithmically guided manual process—an operator of the system (100) can be guided by a customer, expert, etc. to provide parameters that will facilitate segmentation based on which areas are of most interested. With the alignment/registration technique providing a pixel/voxel definition for various components or sub-assets to be tracked, a CAD file of the asset (e.g., a CAD file of a process vessel—the process vessel being the volumetric space being inspected) can be used to identify points of the asset so as to allow the system (100) to know what is a volume of interest—the CAD file of that asset can be used to identify only points that are “asset points”, and the system (100) can align the CAD file to the baseline image and delete any points outside of a threshold value(s). After this is completed, the defined array locations making an area of interest or voxel mapping to define a volume of interest can be used to query scalar data for subsequent inspections.

In addition (e.g., augmenting the above segmentation process, making the segmentation fully automatic, etc.), or in the alternative, other techniques can be used. These can include mathematically selecting unique blocks/shapes (e.g., Segment Anything Model or (SAM)), an ML algorithm that has been trained to recognize certain items/assets (e.g., powerlines, process piping, structural elements, etc.), etc.

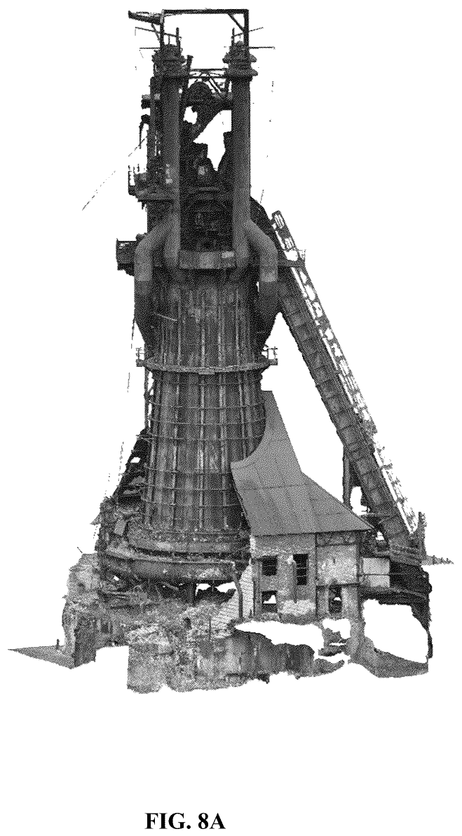

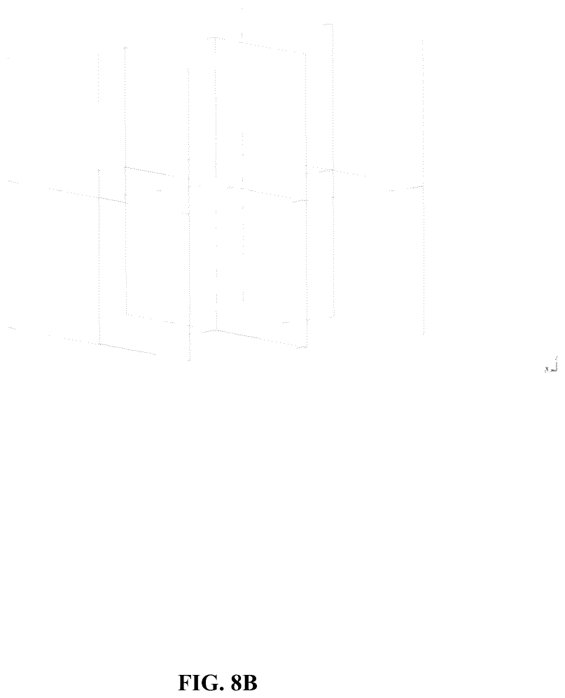

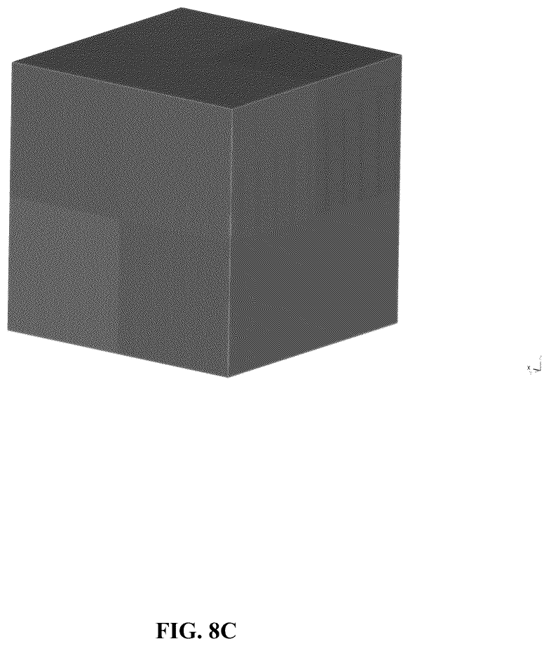

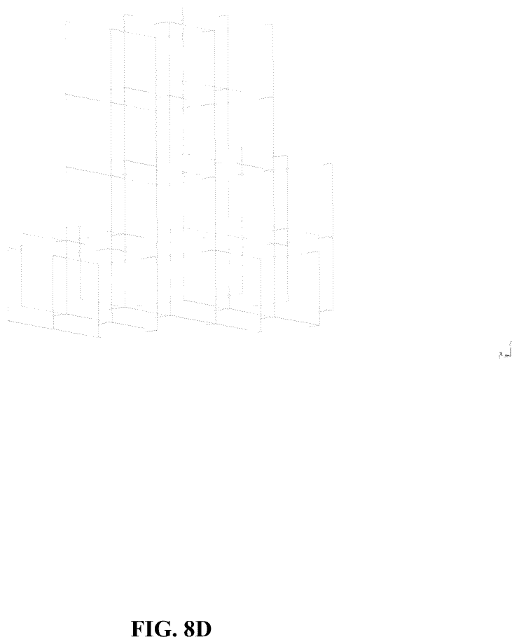

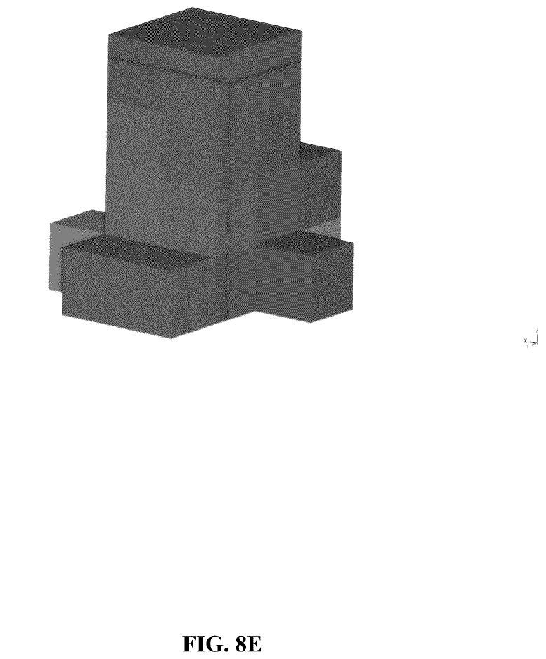

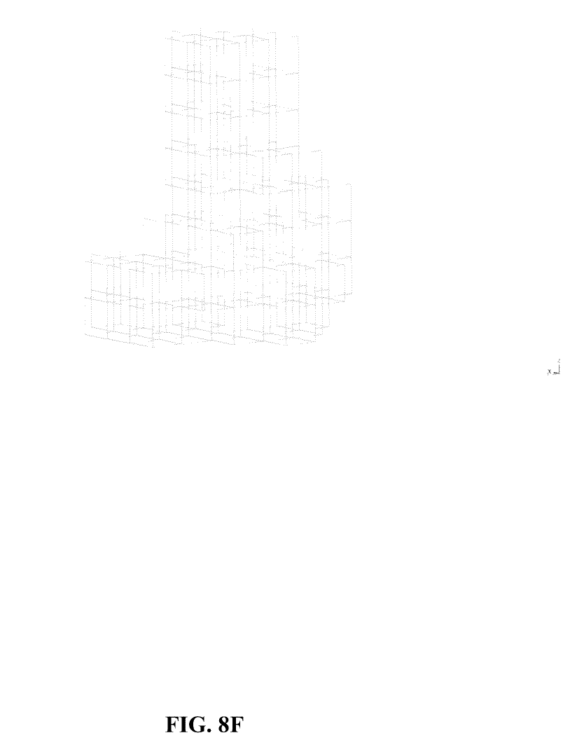

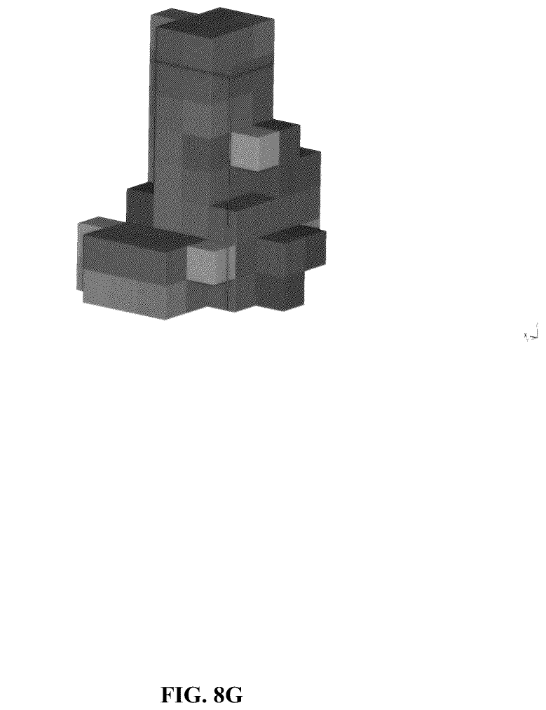

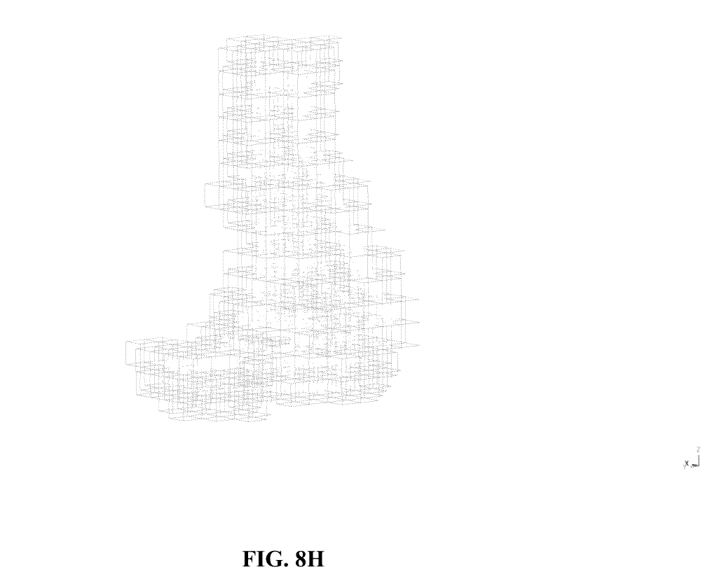

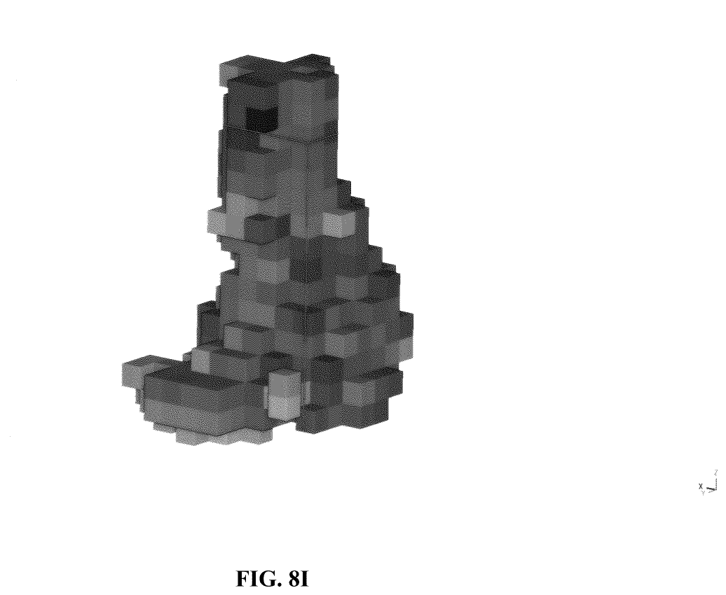

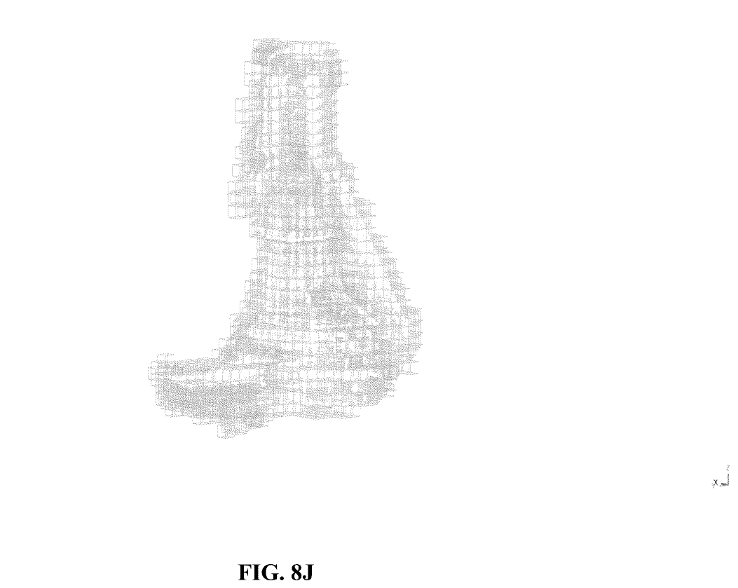

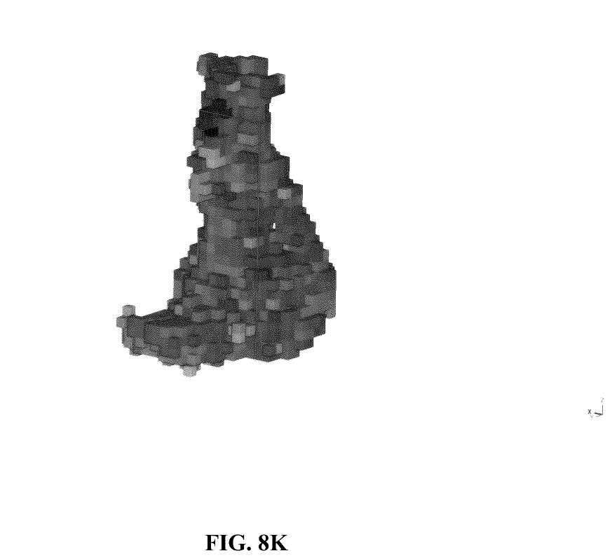

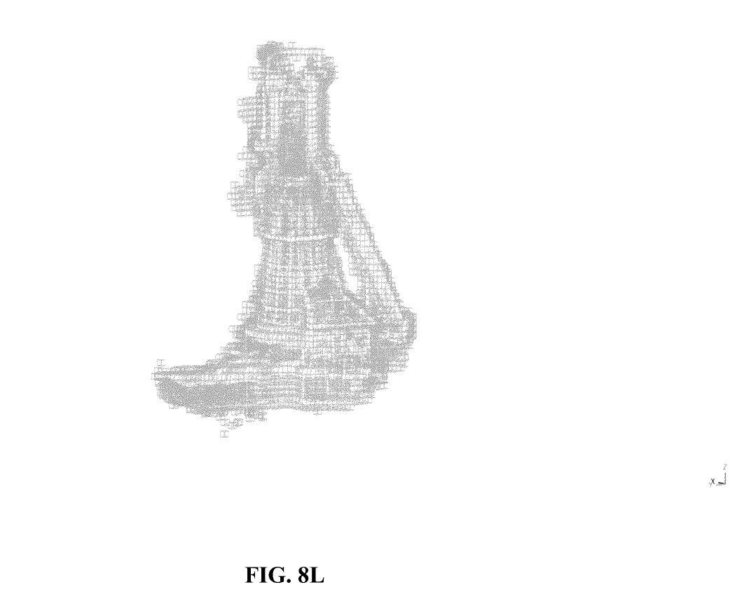

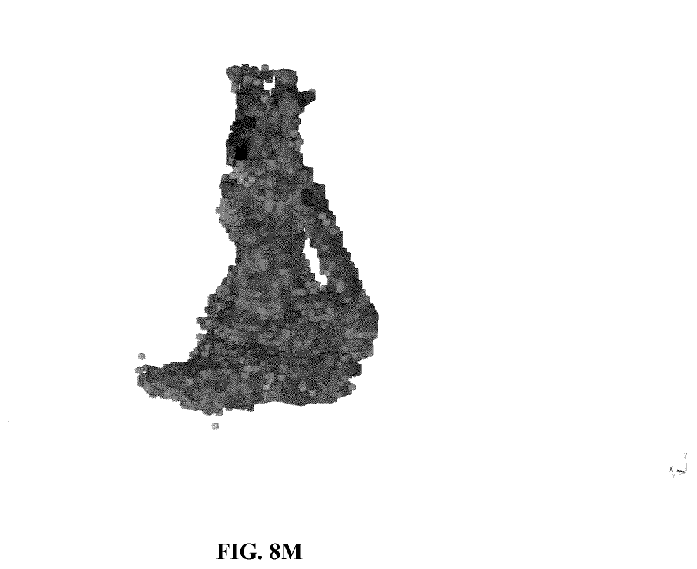

A distinguishing feature of the present invention lies in its ability to define and independently track a vast number of areas or volumes within a monitored volumetric space, each corresponding to physical surfaces, objects, or components—the corresponding physical surfaces, objects, or components being identified/defined by the segmentation process. For instance, after segmentation has been performed, a large dataset can be subdivided into plural areas/volumes of interest, wherein each subdivision can be inspected, monitored, tracked, etc. independently of each other. While it is contemplated for each subdivision to be inspected, monitored, tracked, etc. independently, it is understood that any number of them can be inspected, monitored, tracked, etc. independently, in combination with others, in parallel with others, one subdivision can be inspected, monitored, tracked, etc. based on data from another subdivision, etc. By applying a coordinate system to the data generated by the multi-modal sensor module, the system enables the creation of virtual sensors that are not constrained by human perceptual or cognitive limitations, but rather by computational resources. Each virtual sensor is configured to monitor the most granular definition of a sub-system or component within the volumetric space. Again, the sub-system or component is identified/defined by the segmentation process. For instance, for a given 2D perspective, pixel locations representative of a physical space within the image frame being monitored, and if the image from that perspective can be properly aligned to the baseline then those known pixel locations will provide the system (100) data to use in a trending/analysis, for example. Additionally, the same can be said for a 3D perspective. Specific volumes can be similarly defined by selecting a portion to be monitored based on baseline model data, wherein voxels are defined (e.g., via use of an Octree system) to set that as a volume for inspection. Provided the alignment of subsequent models is performed well back to this baseline, that voxel definition will allow the system (100) to query all models for data in that specific voxel space. FIGS. 8A-8M show a mathematical sub-division technique using an “octree” system. This technique can be a recursive division of a cube into eight equally sized smaller cubes. This can be used to arbitrarily assign virtual cubic spaces to monitor of all spaces containing data (and likely flag if there is a statistically significant change in that space). The segmentation process, however, can be purely algorithmic (octree for example or (SAM) segment anything model), manual (hand defining spaces), manually guided algorithmic process of defining what volumes/areas are desired to be tracked/monitored, etc.

Accordingly, an asset or process is best monitored by a plurality of such virtual sensors, enabling comprehensive and scalable monitoring of all relevant sub-systems and components. The ability to monitor these elements at scale is critical for ensuring the reliability and operational integrity of complex systems, as failures or malfunctions in individual components can have substantial impacts on overall system performance and value. An exemplary monitoring technique suitable for conducting trend analyses, forecasting, and related diagnostics is temperature monitoring via thermography. Thermography enables the detection of temperature anomalies in physical assets by analyzing thermal images to identify deviations from expected thermal behavior. For example, in a power transmission system comprising several insulators, a thermal image that captures all insulators in the same frame may clearly reveal-visually and intuitively-that one insulator is significantly hotter than the others. Such a scenario is readily identifiable by human inspection. However, in cases where similar component types are not captured within the same image frame, identifying temperature anomalies becomes substantially more difficult through thermography observation alone. In these cases, the system (100) addresses this limitation by computing the average temperature and standard deviation for each component individually. By performing the same analysis across all relevant components, the system (100) can algorithmically determine whether any component exhibits a statistically significant temperature increase relative to others. While variations in ambient conditions may explain certain temperature differences, this form of automated, data-driven analysis provides a more rigorous and objective method than relying on subjective human interpretation. Additionally, the system (100) supports thermographic analysis focused on temperature differentials-referred to as “delta T”-rather than absolute temperature values. Conventional thermography often requires a manual process in which operators capture, analyze, and compare thermal images taken at different time intervals to detect changes. In contrast, the inventive system (100) automates this process by aligning subsequent thermal images or 3D thermal models with a previously established baseline and each new data point is compared to its spatially nearest counterpart in the baseline image or model, and the resulting temperature difference is recorded and analyzed as a new scalar field values that reflect changes in temperature over time. This approach aligns with the practical focus of many asset owners, who are typically more interested in identifying trends in temperature behavior than in measuring absolute temperatures. By emphasizing delta T, the system (100) offers enhanced value through its ability to track evolving conditions. While environmental variables are inherently dynamic, the disclosed method provides a structured and reliable means to assess and isolate the impact of such factors on component performance.

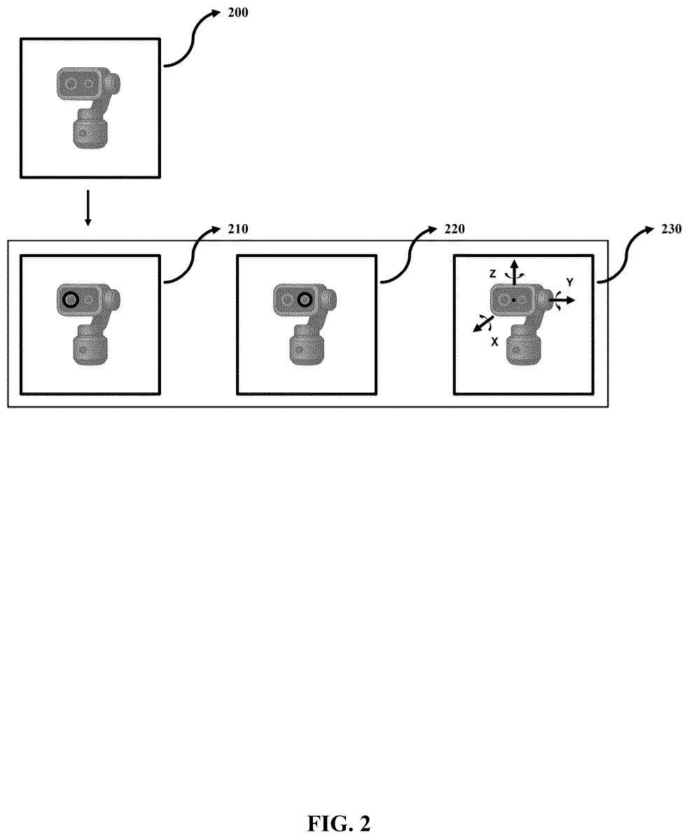

As illustrated in FIG. 2, the Multi-Modal Sensor Module (200) comprises at least one imaging modality operable in a non-visual wavelength spectrum, such as a radiometric infrared camera, optical gas imaging camera, or acoustic imaging camera (210). The specific type of data collected by the non-visual wavelength spectrum imaging modality (210) is dependent on the device employed within the module and is referred to herein as scalar field data. Scalar field data may represent physical properties such as apparent temperature, the presence of atmospheric hydrocarbons or other gases, noise, or other measurable values. The Multi-Modal Sensor Module (200) further comprises a spatial sensor modality (220) and a localization sensor modality (230). The spatial sensor modality (220) is configured to perform spatial sensing, such as mapping three-dimensional structures or identifying spatial features for image registration, and may include sensors such as LiDAR or visual spectrum cameras. The localization sensor modality (230) is configured to provide accurate positional information of the Multi-Modal Sensor Module (200) while within the volumetric space being monitored. The integration of these modalities is primarily to apply a coordinate system to the scalar field data generated by the imaging modality (210), thereby enabling precise spatial referencing and subsequent analysis of the monitored volumetric space.

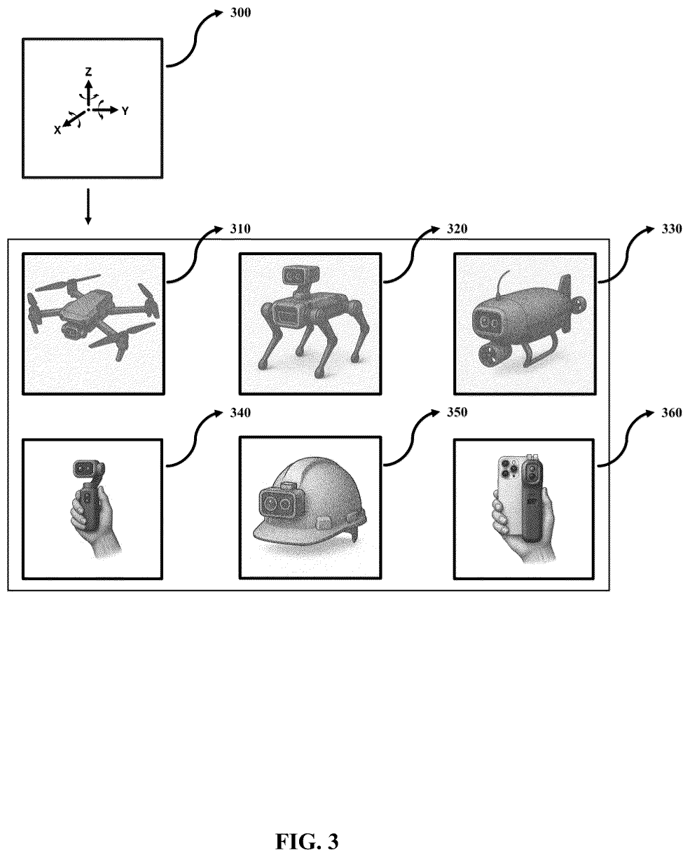

As illustrated in FIG. 3, the Mobility Platform Module (300) is configured to carry, integrate, and/or position the Multi-Modal Sensor Module (200) within a volumetric space. The Mobility Platform Module (300) provides the capability to translate the sensor module in three-dimensional space, which may be defined in terms of X, Y, and Z coordinates, or alternatively by latitude, longitude, and altitude, depending on the navigation system employed. Using a GPS-enabled mobility platform as an exemplary navigation system, the system (100) can develop a frame of reference by seeding each photogrammetry input with a GPS coordinate. The model is properly scaled and spatially positioned for accuracy. While RTK data can be used to augment GPS, even RTK augmented GPS accuracy drifts from day to day, requiring consistency in RTK base station setup and input of base station location to compensate for error due to drift. A best practice can be to create one or more physical target and always reference it/them.

In addition to translational movement, the platform is further configured to control the orientation of the sensor module, including roll, pitch, and yaw, thereby enabling precise directional alignment of the sensing modalities. For instance, the system (100) can determine and apply parameters for precise directional alignment by reviewing images collected at a waypoint(s) and considering sensor orientation to identify which direction a sensor(s) was/were pointed. Operating parameters can then be generated and issued as control signals to the sensing modalities to adjust pitch, roll, etc. to achieve precise directional alignment. The Mobility Platform Module (300) encompasses a range of embodiments, including autonomous unmanned aerial vehicles (UAVs) (310), autonomous ground vehicles (AGVs) (320), autonomous underwater vehicles (AUVs) (330), handheld devices (340), wearable devices (350), and mobile phones with sensor augmentation attachments (360). This flexibility allows for data collection across diverse terrains and environments, including airborne, terrestrial, and aquatic domains. Across these embodiments, some platforms may utilize GPS or similar navigation technologies, while others, such as handheld or wearable devices, do not require such systems. Furthermore, even platforms traditionally associated with GPS navigation, such as UAVs or AGVs, may be configured to operate in GPS-denied environments through alternative localization or navigation methods. Alternative localization and navigation methodologies for operation in GPS-denied environments may include vision-based systems such as those employed by commercial platforms like Skydio and GatherAI. These systems typically leverage onboard video odometry, often in combination with inertial measurement units (IMUs), to implement simultaneous localization and mapping (SLAM) or visual SLAM (VSLAM). This approach facilitates both real-time navigation and obstacle avoidance by constructing voxel-based or point cloud representations of the environment during flight. A further alternative involves the use of LiDAR-based mapping systems, which enable high-resolution, onboard spatial mapping and obstacle detection. Notably, companies such as Flyability have demonstrated the utility of LiDAR-equipped unmanned aerial vehicles (UAVs) in navigating complex or confined environments. Another category of localization solutions involves the use of fixed-position beacons emitting signals such as Ultra Wideband (UWB), Wi-Fi, or similar communication protocols. In such systems, the mobile platform triangulates signals from multiple beacons to determine its position in three-dimensional space. However, this beacon-based approach provides only positional awareness and does not inherently support obstacle detection or avoidance. The mobile phone with sensor augmentation attachment (360) is distinguished as an add-on to existing inspection tools and routines, enabling the enhancement of conventional inspection workflows. The platform may be operated manually by an individual, such as through a handheld or wearable device, or may be configured for autonomous operation, either under the guidance of an operator via an interface like a remote control or through pre-programmed mission parameters for fully autonomous execution. This broad adaptability ensures that an appropriate embodiment can be deployed in nearly any environment, enabling comprehensive and flexible data collection strategies tailored to the requirements of the monitored volumetric space.

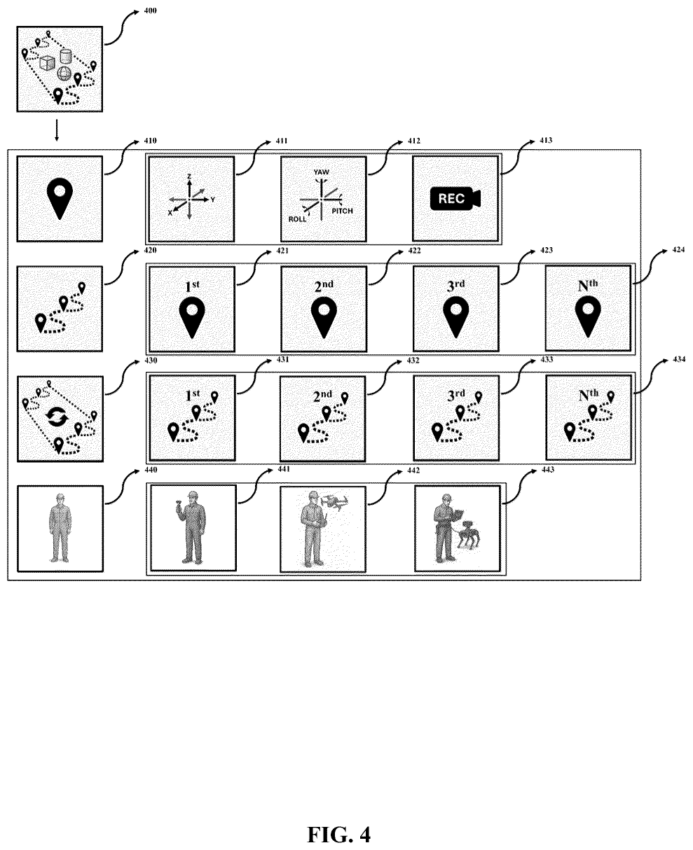

As illustrated in FIG. 4 and its subfigures, the Navigation and Mission Execution Module (400) is responsible for defining and executing a navigable mission plan within the monitored volumetric space. A key element of this module is the waypoint (410, FIG. 4A), which represents a specific position within the volumetric space, defined by coordinates such as X, Y, and Z or, alternatively, latitude, longitude, and altitude. Each waypoint is associated with localization data (e.g., localization metadata), which is essential for establishing a coordinate system and ensuring accurate spatial referencing data collect. In addition to position, each waypoint includes an orientation component (412, FIG. 4A), specifying the directionality of the multi-modal sensor module (200) to enable precise pointing of the sensor. Furthermore, a waypoint may include a modality-independent sensor action (413, FIG. 4A), such as initiating or terminating data recording, capturing an image, or specifying that no action is required at that location. For instance, a navigable mission plan may include several waypoints, with the first waypoint initiating a sensor action (e.g., start recording). Subsequent waypoints may serve purely for repositioning and reorienting the platform while continuous data acquisition-such as video or LiDAR scanning-occurs. The final waypoint may then terminate the sensor action (e.g., stop recording). Alternatively, depending on the sensing modality and mission objectives, certain waypoints may specify that no sensor action is required, serving solely as navigational markers for positioning and orientation control. The combination of position, orientation, and action at each waypoint enables flexible and targeted data collection strategies.

Building upon the concept of waypoints, a navigable mission plan (420, FIG. 4B) is constructed as a sequence of waypoints or target locations connected by a path, which may be a straight lines or a spline. The mission plan is designed to safely traverse areas or features of interest within the volumetric space, and the figure exemplifies this by showing a 1st, 2nd, 3rd, and Nth waypoint (421-424, FIG. 4B). The mission plan represents an instance of inspection, and corresponding data collected therefrom represents a discrete point in time, even though the inspection process may involve continuous movement or data acquisition along the defined path.

To facilitate time series analysis, the system supports repeated execution of a navigable mission plan (430, FIG. 4C), with each execution providing an additional discrete point in time for comparative analysis. The repeated execution is illustrated by a series of mission plans (431-434, FIG. 4C), each corresponding to a separate inspection instance. This approach enables the system to monitor changes, trends, or anomalies within the volumetric space over time by comparing data collected from multiple, repeatable inspection instances.

The manner in which the mission plan is executed is determined by the operator control mode (440, FIG. 4D), which is influenced by both the operator and the configuration of the mobility platform module (300). In the operator guided mode (441, FIG. 4D), the operator directly positions and orients the multi-modal sensor module (200), typically by physically carrying or manipulating the platform. While this mode offers flexibility, it may be limited in terms of exact positioning repeatability. In the operator-controlled mode of a remote capable mobility platform (442, FIG. 4D), the platform is capable of self-positioning and orientation, but is controlled in real time by the operator via an interface such as a remote control. This mode leverages more precise positioning capabilities, but still introduces the potential for human error. The operator programmed mode of an autonomous capable mobility platform (443, FIG. 4D) utilizes software to execute the mission plan autonomously, optimizing for repeatability and efficiency. Although even autonomous systems may experience deviations between targeted and actual positions, the use of localization data and feedback loops can minimize such errors, making this mode the most repeatable and cost-effective, particularly in terms of reducing operator labor requirements. This comprehensive approach to navigation and mission execution enables the system to adapt to a wide range of operational scenarios and user requirements, as supported by the claims and illustrated in FIG. 4 and its subfigures.

The selection of an analysis strategy, whether processing two-dimensional or three-dimensional data, is closely interrelated with mission planning. In practice, the desired analysis strategy-such as a two-dimensional, three-dimensional, or hybrid approach-will dictate how the mission is planned and executed, including the density, type, and pattern of spatial sensing performed. Each analysis strategy presents distinct technical advantages and limitations; for example, a two-dimensional approach may offer greater efficiency and simplicity for certain applications, while a three-dimensional approach may provide enhanced spatial resolution and context at the cost of increased data acquisition and processing requirements. The choice between these strategies, or the adoption of a hybrid methodology, is therefore influenced by the specific objectives and constraints of the monitoring application. The choice can be made by an operator, a cost or objective function, by a ML algorithm, etc. This interplay between mission design and analysis strategy ensures that both are optimized to achieve the desired monitoring outcomes.

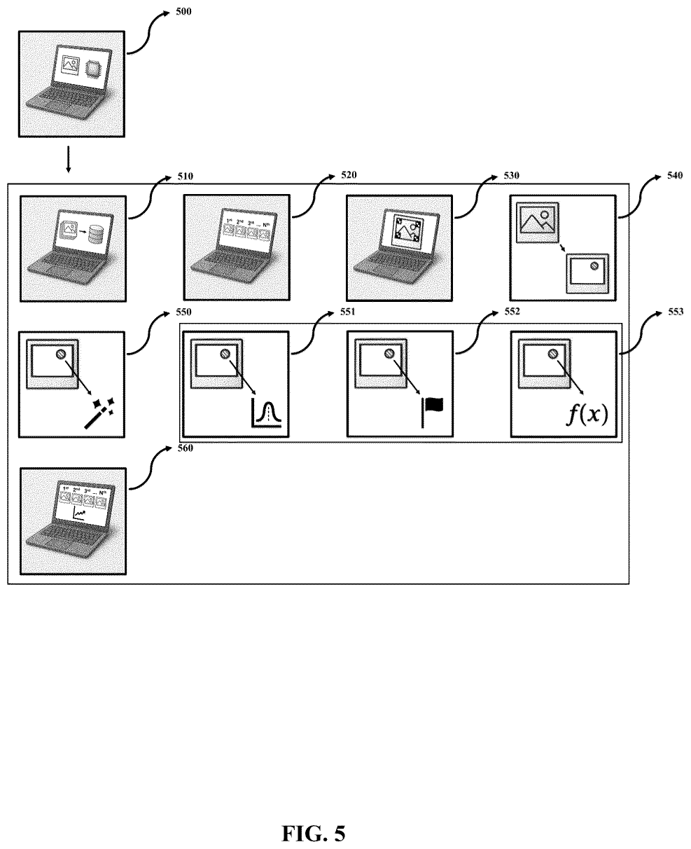

As illustrated in FIG. 5, the two-dimensional (2D) data processing strategy (500, FIG. 5) is supported by claims 9, 10 (i), 11, and 12. In this approach, each image or data array acquired by the multi-modal sensor module (200) is associated with precise localization metadata, enabling the system to record the spatial position and orientation at the time of capture. This localization is critical, as it allows subsequent inspections or repeated executions of mission plans to generate a temporal series of corresponding images or orthogonal projections of the monitored volumetric space (510, FIG. 5). As a result, the system can assemble a dataset in which physical surfaces or features are consistently represented across corresponding images or data arrays from multiple inspection instances (520, FIG. 5).

All non-visual spectrum images are stored in a manner that enables efficient querying and retrieval of corresponding images or those of similar perspective (510, 520, FIG. 5), thereby facilitating the construction of temporal series for each orthogonal projection. However, due to inherent positioning or orientation errors in the mobility platform, there may be slight variations in perspective between images, resulting in differences in exact pixel array location to physical surface and therefore reducing comparative reliability. To address this, the system may utilize all or a single available modality-localization, spatial sensing, and non-visual spectrum data-to perform image registration or alignment (530, FIG. 5), employing techniques such as feature-based matching, mutual information, or photogrammetric adjustment. Through this process, the system ensures that each pixel location within an array is consistently mapped to a physical position in the volumetric space across the entire image series.

Following registration, the system performs spatial segmentation (540, FIG. 5) to define areas of interest within each image, thereby generating virtual sensors. These virtual sensors may correspond to individual pixels or, more commonly, groupings of pixels that represent specific physical components or sub-systems within the monitored volumetric space. The segmentation process can be applied consistently across the entire image series, enabling the creation of persistent references for time series analysis.

The scalar field data associated with each virtual sensor can be further augmented through a variety of techniques (550, FIG. 5). Basic statistical summarization (551, FIG. 5), such as calculating the mean or standard deviation, provides insight into the behavior of each virtual sensor over time. Subject matter expertise or regulatory guidelines may be incorporated into logic structures (552, FIG. 5) to generate notifications or flags based on threshold values or changes in value. More advanced techniques, such as physics-based modeling, finite element analysis (FEA), or computational fluid dynamics (CFD), may be employed to transform raw sensor data into inferred values, utilizing reduced order models (ROM) (553, FIG. 5) to facilitate efficient analysis. The specific augmentation techniques applied are dependent on the type of data generated by the non-visual spectrum imaging modality within the multi-modal sensor module.

By assembling a temporal series of data points for a plurality of virtual sensors, the system enables independent tracking of numerous hyper-local regions (sub-system, component, etc.) within the volumetric space. Each virtual sensor signal can be analyzed using trending, forecasting, statistical modeling (e.g., linear regression), anomaly detection, or artificial intelligence-based methods (560, FIG. 5). This robust 2D data processing strategy (500, FIG. 5) provides a scalable and flexible framework for monitoring, analyzing, and interpreting changes within complex volumetric environments.

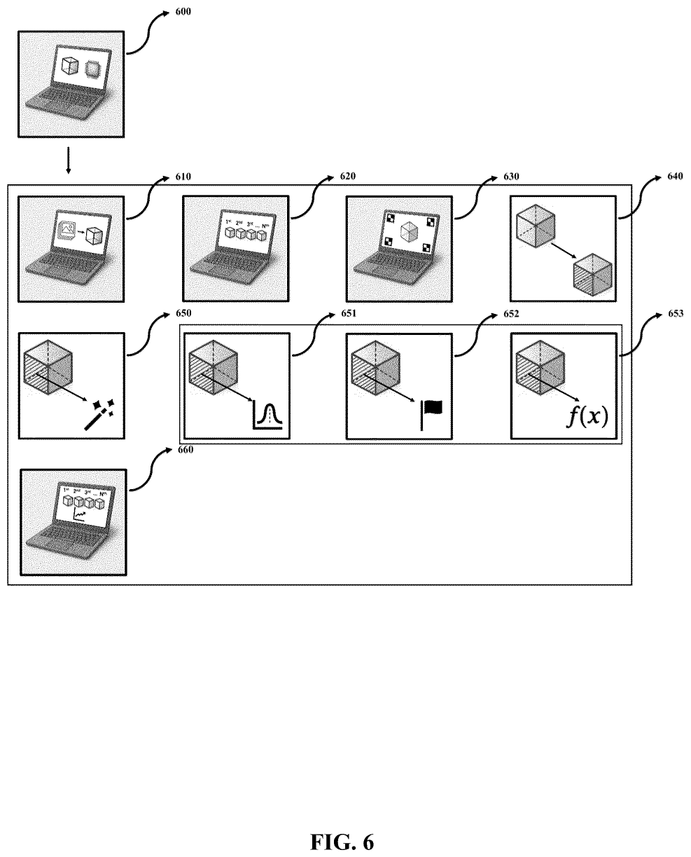

As illustrated in FIG. 6, the three-dimensional (3D) data processing strategy (600, FIG. 6) is supported by claims 10(ii), 11, 13, 14, 15, and 16. In contrast to the 2D approach, the 3D strategy requires the collection of sufficient data to generate a comprehensive 3D model of the monitored volumetric space. This may involve extensive mission planning and data acquisition, particularly when the spatial sensing modality employs image-based reconstruction techniques, which typically require many images and perspectives. Alternatively, the use of native spatial sensing modalities, such as LiDAR or time-of-flight sensors, may enable more efficient 3D model generation with fewer data points and reduced computational effort.

In the 3D approach, the non-visual spectrum modality images or data arrays from each inspection instance are consolidated into a single 3D dataset for storage (610, FIG. 6). Each data point or voxel, analogous to a pixel in 2D, is referenced within the spatial framework of the 3D model, which may be represented as a point cloud, mesh, neural radiance field, or Gaussian splat. For each inspection instance, a complete 3D model with associated scalar field data is generated, and a series of such models is assembled for direct comparison across multiple inspection instances (620, FIG. 6.

To enable comparative analysis, the system performs registration and alignment of the 3D models (630, FIG. 6). This process may utilize the models themselves for mathematical best-fit alignment, leveraging the coordinate system and localization data, or may employ physical targets, computer vision targets, or ground control points placed within the volumetric space to serve as reference features for precise registration. This ensures that each 3D dataset is consistently aligned within a common spatial reference frame, facilitating accurate comparison of scalar field data across time.

Following registration, the system performs spatial segmentation (640, FIG. 6) to define volumes of interest within each 3D model, thereby generating virtual sensors. These virtual sensors may correspond to individual voxels or groupings of voxels, or may be defined within other 3D data structures such as meshes, point clouds, neural radiance fields, or Gaussian splats. The segmentation process is applied consistently across the series of 3D models, enabling persistent volumetric references for time series analysis.

The scalar field data associated with each virtual sensor can be further augmented through a variety of techniques (650, FIG. 6). Statistical summarization (651, FIG. 6), such as calculating the mean or standard deviation within a volume of interest, provides insight into the behavior of each virtual sensor over time. Logic-based structures (652, FIG. 6) may incorporate subject matter expertise or regulatory guidelines to generate notifications or flags based on threshold values or changes in value. Advanced modeling techniques, including physics-based modeling, finite element analysis (FEA), computational fluid dynamics (CFD), and/or reduced order modeling (653, FIG. 6), may be employed to transform raw sensor data into inferred values, supporting efficient and meaningful analysis. The specific augmentation techniques applied are determined by the type of data generated by the non-visual spectrum imaging modality within the multi-modal sensor module.

By assembling a temporal series of 3D models (e.g., a 3D model being vertices and edges of volumetric space data encoded with temporal data (e.g., metadata) and stored as arrays in memory 102), each with a plurality of virtual sensors, the system enables independent tracking and analysis of numerous volumetric regions within the monitored space. Each virtual sensor signal can be analyzed using trending, forecasting, statistical modeling, anomaly detection, or artificial intelligence-based methods (660, FIG. 6). The use of a common coordinate system across all 3D models allows for direct comparison of scalar field values at like spatial locations, providing a robust and scalable framework for monitoring, analyzing, and interpreting changes within complex volumetric environments.

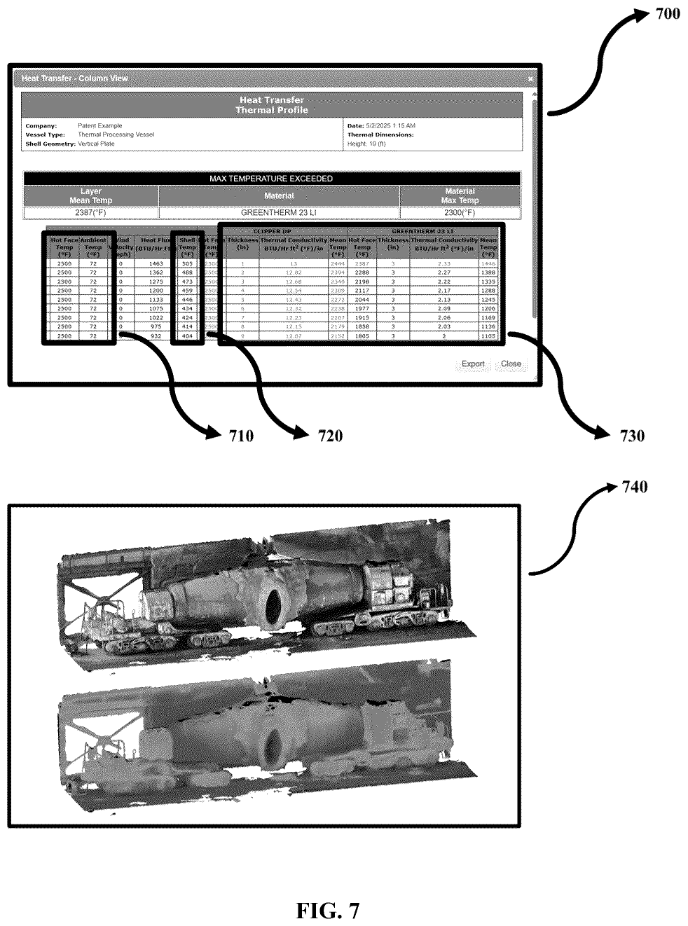

In one particular embodiment, as illustrated in FIG. 7, the system is applied to the monitoring of a volumetric space that contains a refractory-lined thermal processing vessel operating at elevated temperatures. The embodiment utilizes a radiometric infrared camera as the non-visual spectrum imaging modality to acquire arrays of apparent temperature measurements across the asset, including the vessel's exterior shell. The vessel's shell, which serves as its thermal envelope, is typically constructed with a metallic outer layer and interior to that layer multiple ceramic layers of refractory materials, each of these layers is characterized by distinct thicknesses and thermal conductivity properties (see FIG. 7, 730). These linings are engineered to provide both a protective barrier against harsh internal process conditions as well as to provide thermal insulation. The vessel geometry, lining design, material properties, internal process temperatures (which may be measured by thermocouples) (see FIG. 7, 710), and ambient external conditions are well-established parameters in input into industry accepted methodologies to calculate theoretical shell temperatures under normal operating conditions and conductive heat transfer assumptions (see FIG. 7, 720). An example of a refractory lined vessel used to transport molten iron is shown by comparing the visual 3D model above a thermal 3D model (see FIG. 7, 740. By leveraging these industry accepted methodologies, the system incorporates a reduced order model to establish a quantitative relationship between measured shell temperatures and internal vessel conditions, particularly the wear or degradation of the innermost refractory lining. As a result, the system enables continuous, non-invasive assessment of vessel integrity and reliability during operation, providing actionable metrics without requiring shutdown or direct internal inspection.

### ITEM DESCRIPTIONS

FIG. 1—Illustrates a schematic diagram of the Volumetric Monitoring System.
100: Volumetric Monitoring System
110: Multi-Modal Sensor Module
120: Mobility Platform Module
130: Navigation and Mission Execution Module
140: Data Processing Module (2D Data)
150: Data Processing Module (3D Data)

FIG. 2—Multi-Modal Sensor Module
200: Multi-Modal Sensor Module
210: Non-Visual Spectrum Imaging Sensor Modality
220: Spatial Sensor Modality
230: Localization Sensor modality

FIG. 3—Illustrates the Mobility Platform Module
300: Mobility Platform Module
310: Autonomous Unmanned Aerial Vehicles (UAVs)
320: Autonomous Ground Vehicles (AGVs)
330: Autonomous Underwater Vehicles (AUVs)
340: Handheld Device
350: Wearable Device
360: Mobile Phone with Sensor Attachment

FIG. 4—Navigation and Mission Execution Module (400) overview
400: Navigation and Mission Execution Module

FIG. 4A-Waypoint
410: Waypoint
411: Position
412: Orientation
413: Modality-independent sensor action

FIG. 4B—Mission Plan
420: Mission plan
421: 1st Waypoint
422: 2nd Waypoint
423: 3rd Waypoint
424: Nth Waypoint

FIG. 4C—Repeated Execution of a Mission Plan
430: Repeated Execution of a Mission Plan
431: 1st Mission Plan
432: 2nd Mission Plan
433: 3rd Mission Plan
434: Nth Mission Plan

FIG. 4D—Operator Control Modes
440: Operator Control Modes
441: Operator Guided of a Mobility Platform
442: Operator Controlled of a Remote Capable Mobility Platform
443: Operator Programmed of an Autonomous Capable Mobility Platform

FIGS. 5—2D Data Processing & Analytics
500: 2D Data Processing & Analytics
510: Instance Data Preparation (Non-Visual Spectrum Images Stored In 2-Dimensional Data Structure By Spatial Reference)
520: Series of Instances Data Preparation (Comparable Corresponding Non-Visual Spectrum Data Arrays)
530: Spatial Registration and Alignment Across Image Series
540: Spatial Segmentation Across Image Series
550: Augmentation of Underlying Scalar Field Data
551: Statistical Summarization
552: Logic
553: Physics-Based Modeling and/or Reduced Order Modeling
560: Trend/Anomaly Detection

FIGS. 6—3D Data Processing & Analytics
600: 3D Data Processing & Analytics
610: Instance Data Preparation (Non-Visual Spectrum Image Data Stored In 3-Dimensional Data Structure)
620: Series of Instances Data Preparation (Comparable 3-Dimensional Datasets)
630: Spatial Registration and Alignment Across 3-Dimensional Datasets
640: Spatial Segmentation Across 3-Dimensional Datasets
650: Augmentation of Underlying Scalar Field Data
651: Statistical Summarization
652: Logic
653: Physics-Based Modeling and/or Reduced Order Modeling
660: Trend/Anomaly Detection

FIG. 7—Industrial Use Case
700: Industrial Use Case (Reduced Order Model for Thermal Processing Vessel and Radiometric Scalar Data)
710: Process (Internal) and Ambient (External) Temperature Inputs
720: Theoretical Apparent Shell Temperature
730: Lining Design of Known Thickness & Thermal Conductivity Properties
740: Example of Industrial Visual vs. Thermal Models

What is claimed is:

1. A system for monitoring volumetric spaces using time-series analysis, the system comprising:
a multi-modal sensor module including at least one imaging modality operable in a non-visual wavelength spectrum, the multi-modal sensor module configured to generate data of a volumetric space;
a mobility platform module configured to carry, integrate, and/or position the multi-modal sensor module, the mobility platform module including a navigable mission plan configured to guide the mobility platform through the volumetric space;
a data processing module configured to:
cause the multi-modal sensor module to perform one or more inspection instances by generating data of the volumetric space in accordance with the navigable mission plan for each inspection instance;
generate one or more scalar field arrays based on a time series analysis of the data, the one or more scalar field arrays being representative of one or more orthographic projections of spatially distributed physical properties of the volumetric space; and
align, compare, and analyze the one or more scalar field arrays to detect a change, a trend, and/or an anomaly within the volumetric space.

2. The system of claim 1, wherein the imaging modality includes:
one or more radiometric infrared cameras;
one or more near infrared cameras;
one or more ultraviolet cameras;
one or more optical gas imaging cameras;
one or more acoustic imaging cameras; and/or
one or more multi-spectral imaging cameras.

3. The system of claim 1, wherein:
the multi-modal sensor module is configured to perform spatial sensing and generate spatial sensing data, wherein the spatial sensing is performed by:
one or more visual spectrum imaging cameras configured to provide an image-based three-dimensional (3D) reconstruction via photogrammetry, neural radiance fields (NeRF), 3D gaussian splatting (3DGS), stereo vision, monocular depth estimation, and/or structured light projection; and/or
one or more active ranging sensors configured to perform direct spatial measurements supported by localization via a LiDAR camera and/or a time-of-flight camera;
the data processing module is configured to derive spatial structure or identify spatial features of the volumetric space from the spatial sensing data.

4. The system of claim 1, wherein:
the data processing module is configured to associate spatial positioning and/or temporal metadata via data obtained from a localization sensor modality of the multi-modal sensor module, wherein the localization sensor modality includes:
one or more global positioning system (GPS) modules;
one or more real time kinetics (RTK) modules;
one or more post processing kinetics (PPK) modules;
one or more inertial measurement units (IMU) modules;
one or more visual odometry (VO) modules; and/or
one or more simultaneous location and movement (SLAM) modules.

5. The system of claim 1, wherein:
the mobility platform is configured to carry, integrate, and/or position the multimodal sensor module in or on an autonomous or operator guided device;
the autonomous or operator guided device includes:
one or more unmanned aerial vehicles (UAVs);
one or more autonomous ground vehicles (AGVs);
one or more autonomous underwater vehicles (AUVs);
one or more handheld devices;
one or more wearable devices; and/or
one or more mobile phones comprising a sensor augmentation attachment for non-visual spectrum modality.

6. The system of claim 1, wherein:
the navigable mission plan includes one or more defined data collection actions along a defined path or coverage pattern through the volumetric space;
the one or more data collection actions include:
one or more discrete data collection actions at one or more sets of waypoints; and/or
one or more continuous data acquisition actions along one or more splines.

7. The system of claim 6, wherein:
the defined path or coverage pattern is based on a two-dimensional analysis, a pixel-based analysis workflow, a three-dimensional analysis, and/or a voxel-based analysis workflow;
one or more sensor modality parameters for the defined path or coverage pattern are optimized for comparative analysis.

8. The system of claim 1, wherein:
the system is configured to execute the navigable mission plan performed autonomously, semi-autonomously, and/or by guided direction of a system operator;
each execution is an instance of inspection;
each instance of inspection repeats the navigable mission plan with consistent sensor modality parameters, consistent mobility platform orientation, and consistent spatial coverage of the volumetric space.

9. The system of claim 8, wherein:
the system is configured to perform a series of inspection instances by repeated execution of the navigable mission plan across plural distinct timepoints;
the data processing module is configured to generate comparative, trend-based, and/or time-series analyses of the volumetric space.

10. The system of claim 1, wherein:
the data processing module is configured to generate one or more data analysis pipelines for analyzing scalar field arrays from a non-visual spectrum imaging device collected from a series of inspection instances, wherein the one or more data analysis pipelines includes:
(i) a two-dimensional analysis pipeline based on comparison of aligned orthographic projections or arrays of scalar field data; and/or
(ii) a three-dimensional analysis pipeline based on comparison of scalar field data mapped to a meshed, point cloud, splat, and/or voxel representations.

11. The system of claim 10, wherein:
the data processing module is configured to convert one or more raw arrays of scalar field data and associated metadata into one or more spatially normalized and temporally sequential data structures for comparative analysis.

12. The system of claim 11, wherein:
the data processing module is configured to perform the two-dimensional analysis pipeline by: a) using localization metadata to identify corresponding scalar field arrays from the at least one imaging modality operable in a non-visual wavelength spectrum across the series of inspection instances; and b) applying spatial sensing data to align the corresponding scalar field arrays at the pixel level using one or more registration techniques, the one or more registration techniques including a photogrammetry target technique, a computer vision target technique, a structure-from-motion (SfM) technique, a scale-invariant feature transform (SIFT) technique, a COLMAP technique, a feature-based matching technique, a mutual information technique, and/or a photogrammetric adjustment technique.

13. The system of claim 11, wherein:
the data processing module is configured to perform the three-dimensional analysis by: a) processing spatial sensing data into a volumetric model; b) using localization metadata to assign scalar field values from the at least one imaging modality operable in a non-visual wavelength spectrum to specific spatial locations, thereby compiling all non-visual spectrum data from a specific instance of inspection into a 3D representation that is directly comparable to other non-visual spectrum data across the series of inspection instances through a common coordinate system; and c) using a photogrammetry target technique and/or a computer vision target technique for registration.

14. The computational methodology of claim 11, further comprising a segmentation routine configured to define virtual sensors as individual pixels, pixel groupings, voxels, or voxel groupings, said virtual sensors being spatially registered for comparative analysis across time.

15. The system of claim 10, wherein:
the data processing module is configured to summarize or transform virtual sensor data using a statistical summarization technique, a rule-based inference technique, a physics-based model technique, a finite element model technique, a computational fluid dynamics technique, and/or a reduced order model technique.

16. The system of claim 1, wherein:
the data processing module includes a time-series analysis engine configured to analyze virtual sensor data across a series of inspection instances to identify a trend, forecast a condition, and/or detect an anomaly within the volumetric space.

17. A method for monitoring volumetric spaces using time-series analysis, the method comprising:
generating data of a volumetric space via an imaging modality operable in a non-visual wavelength spectrum;
guiding a mobility platform via a navigable mission plan;
performing one or more inspection instances by generating data of the volumetric space in accordance with the navigable mission plan for each inspection instance;
generating one or more scalar field arrays based on a time series analysis of the data, the one or more scalar field arrays being representative of one or more orthographic projections of spatially distributed physical properties of the volumetric space; and
detecting a change, a trend, and/or an anomaly within the volumetric space by aligning, comparing, and/or analyzing the one or more scalar field arrays.

18. The method of claim 17, wherein:
guiding the mobility platform via the navigable mission plan involves use of one or more defined data collection actions along a defined path or coverage pattern through the volumetric space.

19. The method of claim 18, wherein:
the defined path or coverage pattern is based on a two-dimensional analysis, a pixel-based analysis workflow, a three-dimensional analysis, and/or a voxel-based analysis workflow.

20. The method of claim 17, further comprising:
repeating the navigable mission plan with consistent sensor modality parameters, consistent mobility platform orientation, and consistent spatial coverage of the volumetric space for each instance of inspection.
